(19) United States
(12) Patent Application Publication
(10) Pub. No.: US 2005/0082049 A1
(43) Pub. Date: Apr. 21, 2005

(54) Plate heat exchanger

(76) Inventor: Viktor Brost, Aichtal (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/969,159

(22) Filed: Oct. 20, 2004

(30) Foreign Application Priority Data
Oct. 21, 2003 (DE) DE 103 48 803.0

(51) Int. Cl. F16L 13/04

(52) U.S. Cl. 165/166; 165/143

(57) ABSTRACT

A plate heat exchanger including a stack of plates having a plurality of aligned openings, where the aligned openings each define a flow channel for a medium and adjacent plates of the stack define flow paths therebetween for the medium. Flanges are provided around the plate openings extending from both sides of the plane of the heat exchanger plates. The flanges extending from one plate side extend around the entire associated opening and the flanges extending from the other side extend around only a part of the opening. The flange extending around only part of the openings are adapted to deflect media flow.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to a plate heat exchanger, and more particularly to a housingless stacked plate heat exchanger.

### BACKGROUND OF THE INVENTION AND TECHNICAL PROBLEMS POSED BY THE PRIOR ART

Housingless stacked plate heat exchangers are known in the art, as disclosed, for example, in U.S. Pat. No. 4,708,199, which illustrates plate formations which may be used to facilitate desired flow of media through the heat exchanger (see, e.g., FIGS. 25 and 26 of the '199 patent). The full disclosure of the '199 patent is hereby incorporated by reference. Since media usually flow in the direction of the least flow resistance, some zones of heat exchanger plates do not participate fully in the heat exchange, as a result of which the efficiency of the heat exchange is adversely affect. In FIGS. 25 and 26, the '199 patent addresses this problem by forming the otherwise plane edge of the openings in such a way that the medium does not flow directly from the inlet in the flow channel to the corresponding outlet, but first it must spread around the inlet before it can flow to the outlet.

Such measures have also been suggested for plate heat exchangers surrounded by a housing, as shown, for example, in DE 38 24 073 A1.

DE 195 19 312 A1, EP 418 227 B1, EP 611 942 A and EP 867 679 A also disclose heat exchangers relevant to this field.

The present invention is directed toward further improving plate heat exchangers in one or more aspects.

### SUMMARY OF THE INVENTION

In accordance with an aspect of the present invention, a plate heat exchanger is provided, including a stack of heat exchanger plates having a plurality of aligned openings, where the aligned openings each define a flow channel for a medium and adjacent plates of the stack define flow paths therebetween for the medium. Flanges are provided around the plate openings extending from both sides of the plane of the heat exchanger plates, wherein each flange extending from one side extends around the entire associated opening and each flange extending from the other side extends around only a part of the opening. The flanges extending around only part of the openings are adapted to deflect media flow.

In one advantageous form of the invention, the flanges extending around the entire associated opening extend to an adjacent plate opening to block medium flow between the associated channel and the flow path between the adjacent plates. In a further form, each of the flanges extending around the entire associated opening extend to another flange extending around the entire adjacent plate opening.

In another advantageous form of the invention, the flanges extending around only a part of the associated opening extend to an adjacent plate opening to restrict medium flow between the associated channel and the flow path between the adjacent plates. In a further form, each of the flanges extending around only a part of the associated opening extend to near another flange extending around only a part of the adjacent plate opening.

In still another advantageous form of the invention, for each plate the flange extending from the one side of the plate is integral with the plate, and the flange extending from the other side of the plate extends from the flange extending from the one side.

In yet another advantageous form of the invention, the flanges extending from the plate plane other side extend to an end remote from the plane, and the flanges extending around the entire associated opening extend from the flange remote end through the opening to an end on the plate plane one side.

According to another advantageous form of the invention, the flanges extending around only part of the openings extend toward matching flanges extending around only part of the openings of an adjacent plate, and a gap having a height less than the spacing between adjacent plates is maintained between the matching flanges.

According to yet another advantageous form of the invention, the flanges extending around only part of the openings are spaced from one another around the openings to define openings therebetween having a height substantially equal to the spacing between adjacent plates.

According to still another advantageous form of the invention, the flanges extending around only part of the openings are spaced from one another around the openings to define openings therebetween having a height substantially equal to the spacing between adjacent plates.

In still another advantageous form of the invention, the flanges extending around only part of the openings extend over about ⅓ to ½ of the total periphery of the opening, with the flanges extending around only part of the openings positioned to deflect a significant part of the media flow into a corner region of the plate heat exchanger before flowing to the path outlet.

### BRIEF DESCRIPTION OF THE DRAWINGS

The invention will be described in the next sections in practical examples. The eight figures show different views of a housingless plate heat exchanger for heat exchange between two media, or details thereof.

FIG. 1 is a perspective view of one embodiment of a portion of a housingless plate heat exchanger according to the present invention;

FIG. 2 is a perspective view of an alternate embodiment of a portion of a housingless plate heat exchanger according to the present invention;

FIGS. 3 and 4 are broken away perspective views of the heat exchangers of FIGS. 1 and 2, illustrating one of the inlet channels;

FIGS. 5 and 6 are broken away perspective views of two plates illustrating an additional feature of an inlet channel according to the present invention;

FIGS. 7 and 8 are broken away perspective views of two plates illustrating yet another embodiment of an inlet channel according to the present invention.

### DETAILED DESCRIPTION OF THE INVENTION

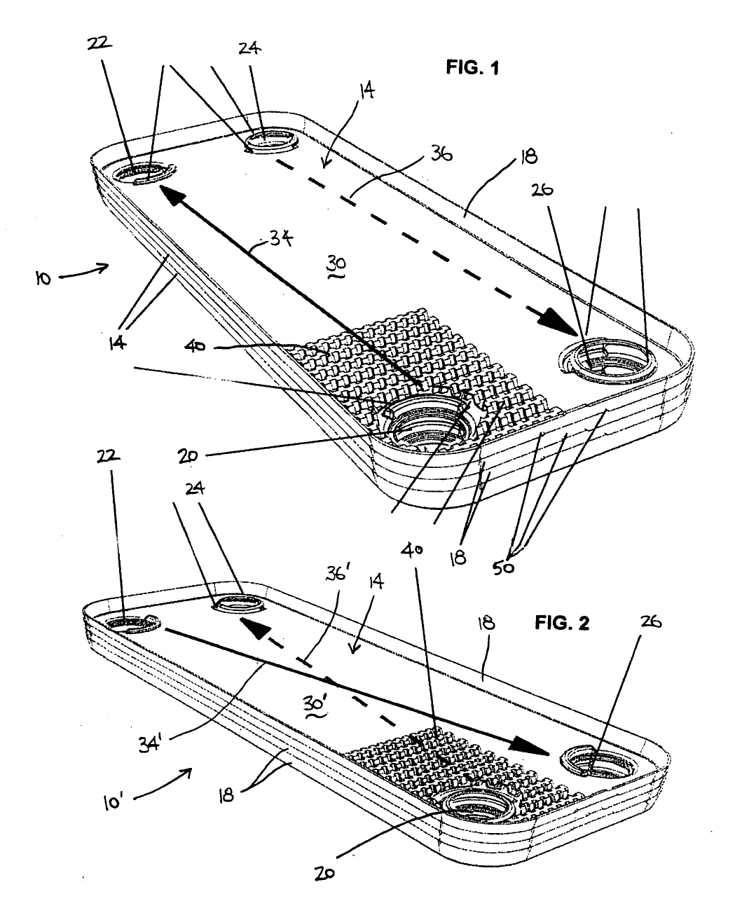

FIGS. 1 and 2 illustrate alternate embodiments of plate heat exchangers 10, 10′ (generally referred to herein by reference number 10 unless specific reference is being made to the FIG. 2 embodiment). These two embodiments are substantially similar and differ principally in providing different flow directions in alternating paths for different media.

The heat exchanger 10 may be used as an oil cooler may have oil as one medium flowing therethrough and a suitable coolant as the second medium, where heat is transferred from the oil to the coolant. However, it should be understood that the present invention may be used with virtually any media, particularly liquid media.

FIGS. 1 and 2 illustrate four stacked rectangular heat exchanger plates 14 defining alternating flow paths therebetween. It should be appreciated, however, that stacked plate heat exchangers 10 may, and usually do, include more than the four plates 14 shown for illustration purposes in FIGS. 1 and 2, and that a heat exchanger 10 embodying the present invention may include multiple additional plates stacked on the illustrated plates 14. The number of heat exchanger plates 14 may be advantageously selected depending on the particular application intended for the heat exchanger 10. It should also be appreciated that the plates 14 do not have to be rectangular.

The plates 14 may be integrally formed with a rim 18 therearound, with the rim 18 being suitably secured to an adjacent plate 14 whereby the flat portions of the plates 14 are spaced apart to define flow paths therebetween. It should be understood, however, that the present invention is not limited to such details, and that the present invention could as well be provided, for example, in a structure in which flat plates are stacked with separate peripheral spacers therebetween providing space for, and enclosing, flow paths between such plates.

In the illustrated embodiments, the plates 14 each include four aligned openings defining inlet and outlet channels 20, 22, 24, 26 for the alternating flow paths.

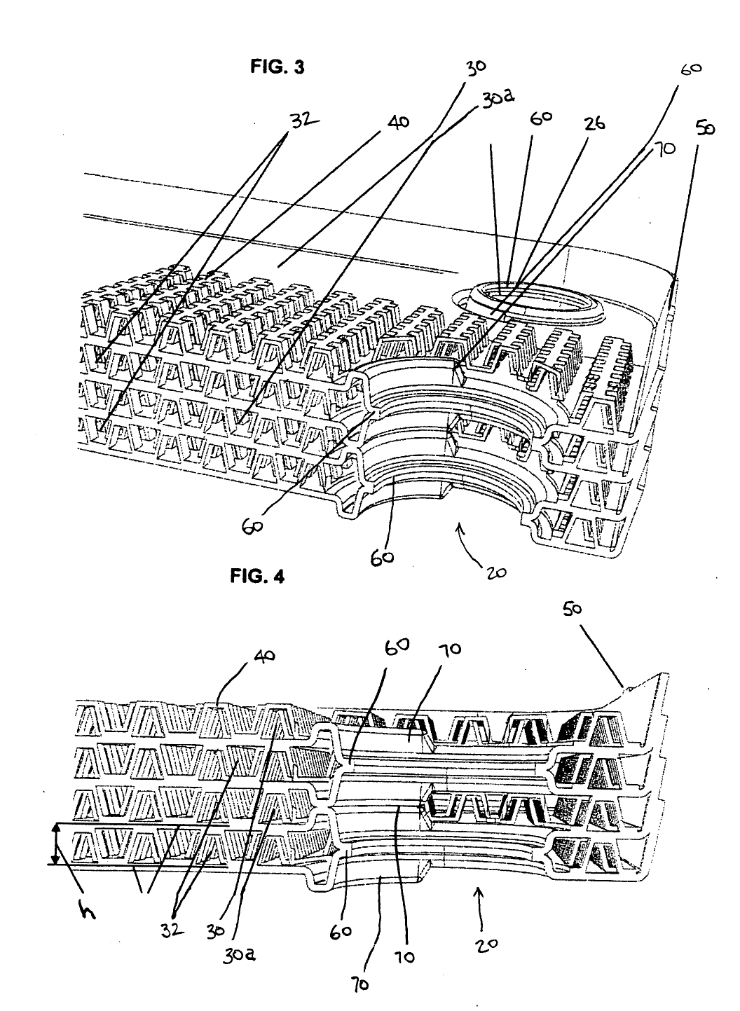

In the FIG. 1 embodiment, channel 20 defines an inlet for the medium which is intended to flow in the path 30 between the upper side of the top illustrated plate 14 and an additional plate (not illustrated) stacked thereon, while channel 22 defines an outlet for that path. Similar paths 30a defined between other plates also provide flow of the medium from aligned openings at those inlet and outlet channels 20, 22 (see FIGS. 3-4).

Channel 24 defines an inlet for the second medium to flow in a path 32 between the lower side of the top illustrated plate 14 and the plate immediately below that plate, while channel 26 defines an outlet for that path. Thus, it should be appreciated that flow in the path 30 will generally be in the direction of arrow 34, whereas flow in the adjacent path 32 below path 30 will be in the direction of dashed arrow 36. Moreover, to best facilitate heat transfer between the media, the paths 30, 32 will advantageously alternate through the stacked plates heat exchanger 10.

In the FIG. 2 embodiment, via the use of different flange structures around the openings as described further below, channel 22 defines an inlet for the medium which is intended to flow in the path 30′ between the upper side of the top illustrated plate 14 and an additional plate (not illustrated) stacked thereon, while channel 26 defines an outlet for that path. Alternating paths 30a′ similarly provide flow from aligned openings at those inlet and outlet channels 22, 26. Similarly, channel 20 defines an inlet for the second medium to flow in a path 32′ between the lower side of the top illustrated plate 14 and the plate immediately below that plate, while channel 24 defines an outlet for that path 30′. Thus, it should be appreciated that flow in the path 30′ will generally be in the direction of arrow 34′, whereas flow in the adjacent path 32′ below path 30′ will be in the direction of dashed arrow 34′.

It should be appreciated that many different variations of flow paths may be readily provided in accordance with the present invention. For example, alternating direction flow paths could be provided, where desired, by blocking selected channels in selected plates 14 such as will be understood by those skilled in the art. In such a case, the channels would be interrupted, in which case one channel (e.g., 20, 24 in FIG. 1, 20, 22 in FIG. 2) would be an inlet for some flow paths and an outlet for other flow paths, and the paired channels (e.g. 22, 26 in FIG. 1, 24, 26 in FIG. 2) would alternately be outlets and inlets for flow paths.

Turbulators 40 may be provided in all flow paths 30, 32 if desired, but are not required to practice the present invention. Moreover, it should be understood that the turbulators 40 may be configured and/or shaped differently from that shown in the Figures, and they could be independent components or components partially or completely integrally formed by protrusions or burls formed in the heat exchanger plates 14, or by similar structures. Furthermore, different turbulator configurations may be provided for different flow paths 30, 32, and the turbulators may only extend only partially, or substantially completely, within an associated path.

As described in greater detail immediately below, the plates 14 are substantially similar but include different configurations at the channels 20, 22, 24, 26 to provide the desired separate flow paths for the two media. Register marks 50 may also be advantageously provided on the rim 18 of the plates 14 to enable optical verification that the plates 14 in the heat exchanger are correctly stacked.

Suitable heat exchanger inlet and outlet connections may be provided to provide for media flow into and out of the heat exchanger 10, whereby, for example, the coolant may be passed through a radiator to be cooled before returning to the heat exchanger 10 and oil may be used in an engine before returning to the heat exchanger 10 to be cooled by heat exchange with the coolant.

In accordance with the present invention, suitable flanges are provided around the openings defining the channels 20, 22, 24, 26.

As illustrated in FIGS. 3 and 4 particularly, ribs or protrusions or flanges 60 are provided to fully surround the channel defining openings to separate the channels for one medium (e.g., 20 and 22 or 24 and 26 in FIG. 1) from paths carrying the other medium (e.g., 32 or 30). These flanges 60 essentially extend fully around the channel and fully between pairs of plates 14 defining flow paths for the other medium. The flanges 60 may be formed in any suitable manner, including stamping of the plate 14. As illustrated, the flanges 60 comprise a half flange from each plate 14, with the half flanges joined together generally halfway between the plates 14. However, it should be understood that this configuration could be provided in any suitable manner, including a flange extending from one plate fully to the flat portion (i.e., the surface plane) of the adjacent plate.

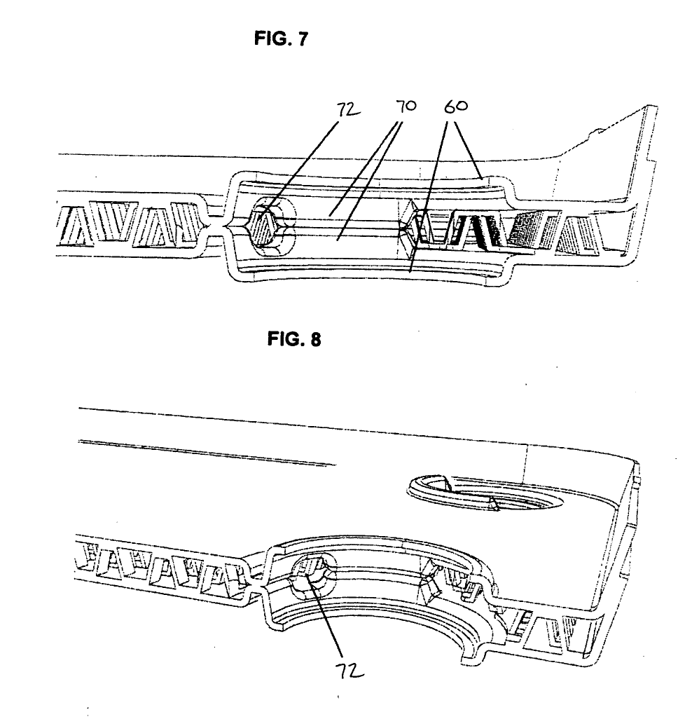

In further accordance with the present invention, partial flanges 70 may be provided around the openings defining channels, where the spaces 72 between the partial flanges 70 serve as inlets or outlets for media between the paths 30, 32 and associated channels 20, 22, 24, 26 (as shown particularly in FIGS. 7-8). Moreover, the partial flanges 70 may be suitably designed to provide desirable flow-deflecting properties, such as deflecting the flow entering the paths 30, 32 from the associated inlet channels (20 and 24 in FIG. 1, 20 and 22 in FIG. 2) into the particular corner regions in which channel (20 and 24 in FIG. 1, 20 and 22 in FIG. 2) is located, after which the media will flow through the path 30, 32 to the corresponding exit channel (22 and 26 in FIG. 1, 24 and 26 in FIG. 2).

For example, the flow-deflecting shape of the partial flanges 70 may advantageously extend about over ⅓ to ½ of the total periphery of the associated opening, with the shape being positioned so that a significant part of the flow is first deflected into a corner region of the plate heat exchanger before it can flow to the corresponding channel. Thus, it should be appreciated that the size and/or number of the spaces 72 can be selected corresponding to the desired division of the flow (FIGS. 7 and 8).

Furthermore, it should be recognized that the illustrated advantageous partial flanges 70 are formed directly at the edge of the particular opening defining the associated channel 20, 22, 24, 26 and the flow-deflecting shape extends radially outwardly. As can be seen in the Figures, the flanges 60 and partial flanges 70 may be suitably formed in an S-shape, with the flange (or partial flange) bent up one direction to a height approximately half the spacing between plates and then bent back down to extend from the opposite side of the plate a distance of approximately half the spacing between plates. A lip on the lower end of the S-shape may be suitably secured to a mating lip on the adjacent plate 14 around the channel to define the flange 60 which blocks the medium from the path intended for the other medium.

As illustrated, the partial flanges 70 may also comprise a half flange from each plate 14, with the half flanges joined together (or advantageously with a gap therebetween as described further below) generally halfway between the plates 14. However, it should be understood that this configuration could also be provided in any suitable manner, including a flange extending from one plate fully to the flat portion of the adjacent plate (with, e.g., slits therein serving as the below described gaps, if desired).

Even in the case of round heat exchanger plates having no corner regions, partial flanges 70 may be advantageously arranged to prevent the media from moving directly from the inlet channel to the outlet channel by causing the media to first spread out around the inlet channel and then flow in the direction of the outlet channel. Similar characteristics at the outlet channels may advantageously also deflect the media before it can enter the outlet channel and leave the plate heat exchanger 10.

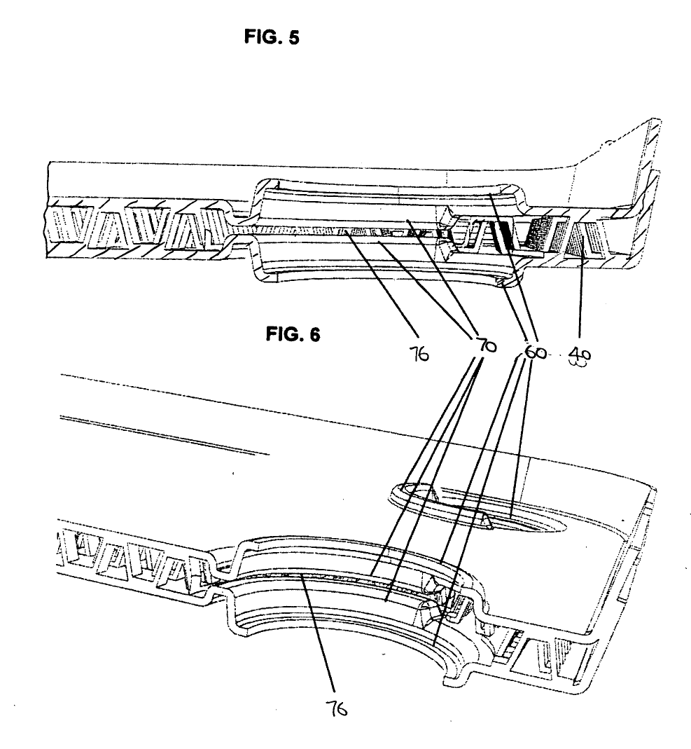

As illustrated in FIGS. 5-6, gaps 76 may also or alternatively be provided between the partial flanges 70, where the gaps 76 have a height less than the height “h” between the adjacent plates. Such a configuration may permit media flow between the channel and the flow path about substantially the entirety of the channel, with flow through the narrower gaps 76 being restricted relative to flow through the substantially full height spaces 72. Such gaps 76 do not eliminate the flow-deflecting property of the partial flanges 70 but, on the contrary, can be advantageously designed in dimension and shape to provide a very targeted division of the flow. Therefore, it should be appreciated that, in contrast to the Figures, the gaps 76 do not have to have a uniform height along their entire length.

It should be appreciated that the flow through the flow paths in heat exchangers according to the present invention will have an intensity providing a great heat transfer efficiency. Moreover, heat exchanger plates according to the present invention are very manufacturing-friendly and consequently help in keeping costs in a very favorable range. Furthermore, the present invention provides a secure structure, and allows shapes such as turbulator elements to be positioned close to the edge of the openings to allow for maximum positive influence of the turbulators in the flow paths on heat exchange.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A plate heat exchanger, comprising:
a stack of heat exchanger plates having a plurality of aligned openings, said aligned openings each defining a flow channel for a medium and adjacent plates of said stack defining flow paths therebetween for said medium;
flanges around said plate openings extending from both sides of the plane of the heat exchanger plates, wherein each flange extending from one side extends around the entire associated opening and each flange extending from the other side extends around only a part of the opening, said flanges extending around only part of the openings being adapted to deflect media flow.

2. The plate heat exchanger of claim 1, wherein said flanges extending around the entire associated opening extend to an adjacent plate opening to block medium flow between the associated channel and the flow path between the adjacent plates.

3. The plate heat exchanger of claim 2, wherein each of said flanges extending around the entire associated opening extend to another flange extending around the entire adjacent plate opening.

4. The plate heat exchanger of claim 1, wherein said flanges extending around only a part of the associated opening extend to an adjacent plate opening to restrict medium flow between the associated channel and the flow path between the adjacent plates.

5. The plate heat exchanger of claim 4, wherein each of said flanges extending around only a part of the associated opening extend to near another flange extending around only a part of the adjacent plate opening.

6. The plate heat exchanger of claim 1, wherein for each plate, said flange extending from said one side of said plate is integral with said plate, and said flange extending from said other side of said plate extends from said flange extending from said one side.

7. The plate heat exchanger of claim 1, wherein said flanges extending from the plate plane other side extend to an end remote from said plane, and said flanges extending around the entire associated opening extend from said flange remote end through said opening to an end on the plate plane one side.

8. The plate heat exchanger of claim 1, wherein said flanges extending around only part of the openings extend toward matching flanges extending around only part of the openings of an adjacent plate, and a gap having a height less than the spacing between adjacent plates is maintained between said matching flanges.

9. The plate heat exchanger of claim 8, wherein said flanges extending around only part of the openings are spaced from one another around said openings to define openings therebetween having a height substantially equal to the spacing between adjacent plates.

10. The plate heat exchanger of claim 1, wherein said flanges extending around only part of the openings are spaced from one another around said openings to define openings therebetween having a height substantially equal to the spacing between adjacent plates.

11. The plate heat exchanger of claim 1, wherein said flanges extending around only part of the openings extend over about ⅓ to ½ of the total periphery of the opening, with said flanges extending around only part of the openings positioned to deflect a significant part of the media flow into a corner region of the plate heat exchanger before flowing to the path outlet.
